(19) United States
(12) Patent Application Publication
(10) Pub. No.: US 2022/0392378 A1
(43) Pub. Date: Dec. 8, 2022

(54) MULTILAYER FILM FOR APPLYING LABELS ON ITEMS OF CLOTHING

(71) Applicant: FRAMIS ITALIA S.P.A., Gaggiano (IT)

(72) Inventor: Matteo CARRARO, Gaggiano (IT)

(21) Appl. No.: 17/751,098

(22) Filed: May 23, 2022

(30) Foreign Application Priority Data
Jun. 3, 2021 (IT) 102021000014438

(51) Int. Cl. G09F 3/02; B32B 27/34; B32B 27/30; B32B 7/12

(52) U.S. Cl. CPC G09F 3/02; B32B 27/34; B32B 27/306; B32B 7/12; G09F 2003/023; G09F 2003/0257; G09F 2003/0282; B32B 2519/00; B32B 2307/7265; B32B 2307/732; B32B 2307/718; B32B 2405/00; B29C 48/08

(57) ABSTRACT

A multilayer film (8) for applying a label (4) to a fabric support (2) by hot pressing includes a lower layer (8a), a barrier layer (8b) and an upper layer (8c). The lower layer (8a) is substantially made of copolyamide, the barrier layer (8b) is substantially made of EVOH, and the upper layer (8c) is substantially made of copolyamide. The film is particularly effective for limiting the migration of pigments from the fabric to the label.

This application claims benefit of Ser. No. 10/2021000014438, filed 3 Jun. 2021 in Italy, and which application is incorporated herein by reference. To the extent appropriate, a claim of priority is made to the above-disclosed application.

### BACKGROUND OF THE INVENTION

The present invention relates to a multilayer film for applying labels to a fabric support; in particular, the present invention relates to a multilayer film having barrier properties for preventing or considerably limiting the migration of pigments from the fabric support to the label.

In the field of packaging fabric items, and in the field of packaging sports clothing items in particular, such as jerseys, T-shirts, jackets, sweatshirts, pants, shorts, vests and the like, it is very important for a label, for example a logo, a number or an image—often the reason for which the consumer purchased the item in question—to remain integral also after several washes.

One of the most felt problems in the field is the label changing color, especially when a label is white; such a phenomenon, which may be observed after the item of clothing has been washed a few times, is due to the migration of the pigments from the fabric to the label and results in the formation of pink or grey rings on the white label.

Usually, the fabric of sports clothing items is made of polyester, while the labels include a surface layer made of thermoplastic polyurethane and an adhesive film which allows the surface layer to be glued to the fabric. The pigments used for coloring the fabric migrate from the polyester to the polyurethane due to the continuous washes, especially due to the effect of the temperature, thus forming the mentioned rings.

To obviate such a problem, some known solutions provide using a film provided with an EVOH layer, which limits the migration of the pigments. However, such a solution has not proven to be effective because the label tends to detach from the fabric after a few washes due to the unsatisfactory adhesive properties of the film.

### SUMMARY OF THE INVENTION

It is the object of the present invention to make a multilayer film for applying labels on a fabric item which meets the needs of the field and overcomes the mentioned drawbacks.

### BRIEF DESCRIPTION OF THE INVENTION

The features and advantages of the multilayer film according to the present invention will become apparent from the following description, given by way of non-limiting example, according to the accompanying drawings, in which:

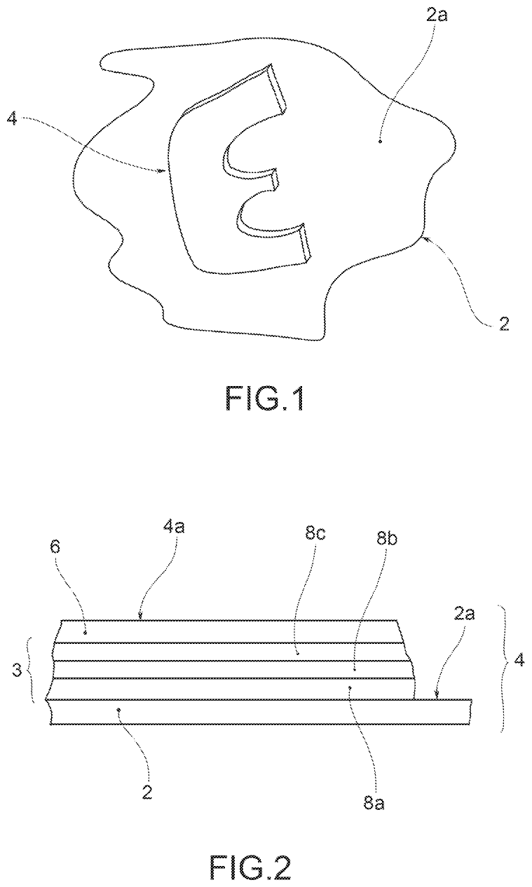

FIG. 1 shows a portion of an item of clothing with a label according to an embodiment of the present invention;

FIG. 2 diagrammatically shows the layered structure of a label comprising a multilayer film according to an embodiment of the present invention;

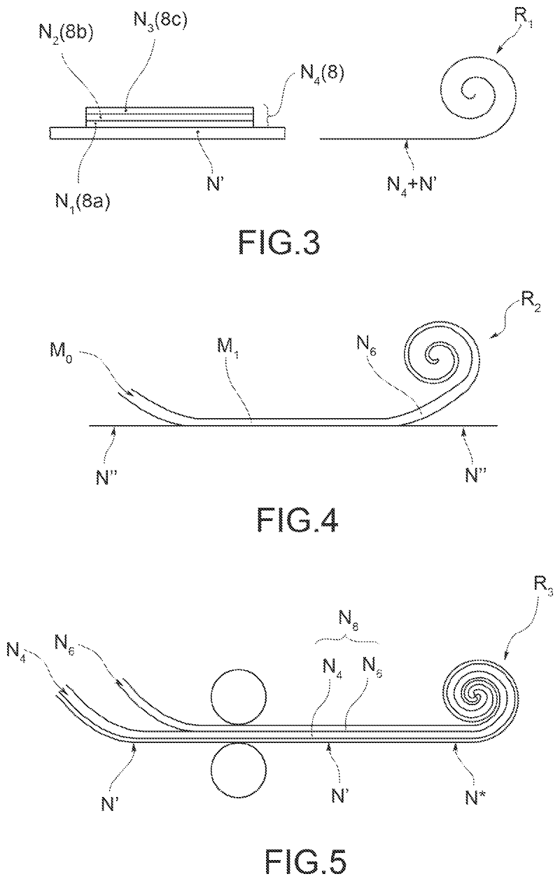

FIGS. 3, 4 and 5 diagrammatically show some production steps of a label strip having the structure of the label according to the present invention.

### DETAILED DESCRIPTION OF THE PREFERRED EMBODIMENTS

With reference to the drawings in the accompanying Figures, a fabric support, for example an item of clothing such as a T-shirt, pants, a jacket and the like, is shown by numeral 2. The fabric is predominantly made of polyester or polyamide or acrylic or natural fibers, such as cotton or linen. Support 2 has an outer surface 2a.

A multilayer label 4 having an outer surface 4a is applied to support 2. Preferably, said label has a thickness between 90 and 170 microns, preferably equal to 150 microns, and a weight between 100 and 190 g/m², preferably equal to 170 g/m².

Preferably, label 4 consists of a surface layer 6 having the outer surface 4a, predominantly made of thermoplastic polyurethane (TPU), and a multilayer film 8 which adheres to the outer surface 2a of support 2.

Film 8 comprises a lower layer 8a made of copolyamide, which adheres to the outer surface 2a of support 2, a barrier layer 8b made of EVOH, overlapping and adhering to the lower layer 8a, and an upper layer 8c made of copolyamide, overlapping and adhering to the barrier layer 8b, which the surface layer 6 overlaps and adheres to.

For example, the lower layer and the upper layer are made of Pontacol (r), supplied by Pontacol AG, while the barrier layer is made of Soarnol (r), supplied by Mitsubishi Chemical Co.

For example, the lower layer and the upper layer have a thickness between 40 and 50 microns, preferably equal to 45 microns, and a weight between 40 and 60 g/m2, preferably equal to 50 g/m2. For example, the barrier layer has a thickness between 15 and 20 microns, preferably equal to 17 microns, and a weight between 10 and 30 g/m2, preferably equal to 20 g/m2.

Advantageously, said multilayer film is capable of considerably limiting or even preventing the migration of the pigments which color the fabric of support 2 towards the surface layer 6 while ensuring an excellent adhesion of the surface layer to the support.

For example, the test for detecting the pigment migration phenomenon is defined by Standard ISO 105-A01 Part A01, ISO 105-A02 Part A02, AATCC Procedure 2. According to such a test, the item of clothing to which the label to be tested is applied, is left in a boiler at a predefined temperature for a predefined time period, for example at 90° C. for 24 hours or at 70° C. for 48 hours. The sample is removed, the label is checked for rings and, using a comparative scale, the color is assigned a value from 5 to 1, where value 5 corresponds to the case when the two compared colors are identical and value 1 corresponds to the case when the two compared colors are very different.

The Applicant, by means of some tests carried out according to the aforesaid standard performed on samples obtained according to the invention, kept in a boiler at 90° C. for 24 hours, has identified a value≥4, that is a color of the tested sample which is practically identical to the original one.

In order to produce the multilayer film according to the present invention, a lower strip N1, having the features of the lower layer 8a, is co-extruded on a non-stick strip N′, for example made of siliconized paper, together with a barrier strip N2, having the features of the barrier layer 8b, and an upper strip N3, having the features of the upper layer 8c. Thereby, a multilayer strip N4 having the features of the multilayer film 4, on non-stick strip N′, wound into a first roll R1, is obtained.

Moreover, a first material M0 is spread over a non-stick strip N″, for example siliconized paper; the solvent present in material M0 evaporates, leaving a material M1 corresponding to the material of the surface layer 6; once the material M1 has cooled, a surface strip N6, having the features of the surface layer 6, is detached from the non-stick strip N″ and wound onto a core, thus forming a roll R2.

Then the rolls R2 and R1 are unwound and the surface strip N6 is rolled onto the multilayer strip N4 supported by the non-stick strip N′, at higher temperatures than the softening temperature, passing over a cylinder or between calenders, with predetermined rolling pressures and speed, thus obtaining a composite strip N* in which a label strip N8 having the features of label 4 is supported by the non-stick strip N′. The composite strip N* is wound into a roll R3, preferably on a cardboard core.

After a predefined time period, for example between 24 and 48 hours, the composite strip N* is subjected to an inspection to identify any visible defects such as lines, dirt, etc. Preferably, the label strip N8 is separated from the non-stick strip N′ and rewound onto a reel.

The object of the marketing is, for example, a reel consisting of the wound label strip N8 (from which the labels were cut in the desired shape) or a reel consisting of the label strip N8 supported by a non-stick strip (especially for making a print and then cutting the label in the desired shape) or of a reel consisting of the label strip N8 coated by a polyester film (especially for carrying out laser cuts for making a logo).

Label 4 is applied to support 2 by means of hot pressing, for example at a temperature of the label and the support between 100° C. and 160° C., preferably between 120° and 140° C., at a pressure between label and support between 4 and 8 bar, preferably equal to 6 bar, for a time period between 10 and 30 seconds, preferably equal to 20 seconds.

Innovatively, the multilayer film according to the present invention meets the needs of the field and overcomes the mentioned drawbacks because it considerably limits or prevents the migration of pigments from the fabric to the surface layer of the label while maintaining an excellent adhesion of the label to the fabric.

It is apparent that, in order to meet contingent needs, those skilled in the art may make changes to the multilayer film described above, all of which are contained within the scope of protection as defined by the following claims.

What is claimed is:

1. A multilayer film for applying a label comprising a surface layer hot pressed to a fabric support, the multilayer film comprising:
a lower layer configured to adhere to the fabric support;
a barrier layer overlapping and adhering to the lower layer; and
an upper layer overlapping and adhering to the barrier layer, the upper layer configured to adhere to the surface layer;
wherein the lower layer is substantially made of copolyamide, the barrier layer is substantially made of ethylene vinyl alcohol (EVOH), and the upper layer is substantially made of copolyamide.

2. The multilayer film of claim 1, wherein the lower layer and the upper layer have a thickness ranging between 40 and 50 microns, and the barrier layer has a thickness ranging between 15 and 20 microns.

3. The multilayer film of claim 1, wherein the lower layer and the upper layer have a thickness equal to 45 microns, and the barrier layer has a thickness equal to 17 microns.

4. The multilayer film of claim 1, wherein the lower layer and the upper layer each have a specific weight ranging between 40 and 60 g/m², and the barrier layer has a specific weight ranging between 10 and 30 g/m².

5. The multilayer film of claim 1, wherein the lower layer and the upper layer each have a specific weight equal to 50 g/m², and the barrier layer has a specific weight equal to 20 g/m².

6. A label configured to be applied to a fabric support by hot pressing, the label comprising:
a multilayer film for applying a label comprising a surface layer hot pressed to the fabric support, the multilayer film comprising
a lower layer configured to adhere to the fabric support,
a barrier layer overlapping and adhering to the lower layer, and
an upper layer overlapping and adhering to the barrier layer, the upper layer configured to adhere to the surface layer,
wherein the lower layer is substantially made of copolyamide, the barrier layer is substantially made of ethylene vinyl alcohol (EVOH), and the upper layer is substantially made of copolyamide; and
a surface layer overlapping and adhering to the upper layer of the multilayer film.

7. The label of claim 6, wherein the surface layer is substantially made of thermoplastic polyurethane (TPU).

8. The label of claim 6, the label having a thickness ranging between 90 and 170 microns.

9. The label of claim 6, the label having a thickness equal to 150 microns.

10. The label of claim 6, the label having a specific weight ranging between 100 and 190 g/m².

11. The label of claim 6, the label having a specific weight equal to 170 g/m².

12. An assembly, comprising:
a fabric support; and
a label configured to be applied to the fabric support by hot pressing, the label comprising:
a multilayer film for applying a label comprising a surface layer to the fabric support by hot pressing, the multilayer film comprising:
a lower layer configured to adhere to the fabric support,
a barrier layer overlapping and adhering to the lower layer, and
an upper layer overlapping and adhering to the barrier layer, the upper layer configured to adhere to the surface layer,
wherein the lower layer is substantially made of copolyamide, the barrier layer is substantially made of ethylene vinyl alcohol (EVOH), and the upper layer is substantially made of copolyamide; and
a surface layer overlapping and adhering to the upper layer of the multilayer film,
wherein the lower layer of the multilayer film adheres to the fabric support.

13. The assembly of claim 12, wherein the fabric support is substantially made of one of polyester, polyamide, acrylic or natural fibers.

14. The assembly of claim 12, wherein said assembly is an item of clothing.

15. The assembly of claim 13, wherein the natural fibers are cotton or linen.

16. A process for making a multilayer film for applying a label comprising a surface layer to a fabric support by hot pressing, the process comprising:
co-extruding a lower layer configured to adhere to the fabric support, a barrier layer overlapping and adhering to the lower layer and an upper layer overlapping and adhering to the barrier layer, the upper layer configured to adhere to the surface layer, wherein the lower layer is substantially made of copolyamide, the barrier layer is substantially made of ethylene vinyl alcohol (EVOH), and the upper layer is substantially made of copolyamide.

17. A process for making a label comprising a surface layer and configured to be applied to a fabric support by hot pressing, the process comprising:
providing a multilayer film comprising a lower layer configured to adhere to the fabric support, a barrier layer overlapping and adhering to the lower layer and an upper layer overlapping and adhering to the barrier layer, wherein the lower layer is substantially made of copolyamide, the barrier layer is substantially made of ethylene vinyl alcohol (EVOH), and the upper layer is substantially made of copolyamide; and
hot rolling the surface layer to the upper layer.

18. A process for making an assembly, the process comprising:
providing a label comprising:
a multilayer film comprising a lower layer configured to adhere to a fabric support, a barrier layer overlapping and adhering to the lower layer and an upper layer overlapping and adhering to the barrier layer, the upper layer configured to adhere to a surface layer, wherein the lower layer is substantially made of copolyamide, the barrier layer is substantially made of ethylene vinyl alcohol (EVOH), and the upper layer is substantially made of copolyamide; and
a surface layer overlapping and adhering to the upper layer of the multilayer film;
providing a fabric support; and
hot pressing the label on the fabric support.

19. The process of claim 18, wherein said assembly is an item of clothing.
